(19) United States
(12) Patent Application Publication
(10) Pub. No.: US 2015/0309874 A1
(43) Pub. Date: Oct. 29, 2015

(54) A METHOD AND APPARATUS FOR CODE LENGTH ADAPTATION FOR ACCESS TO KEY-VALUE BASED CLOUD STORAGE SYSTEMS

(71) Applicant: NTT DOCOMO, INC., Palo Alto, CA (US)

(72) Inventors: Guanfeng LIANG, Sunnyvale, CA (US); Ulas C. KOZAT, Palo Alto, CA (US)

(21) Appl. No.: 14/649,530

(22) PCT Filed: Mar. 13, 2013
(86) PCT No.: PCT/US13/30926

§ 371 Date: Jun. 3, 2015

Related U.S. Application Data
(60) Provisional application No. 61/733,339, filed on Dec. 4, 2012.

(51) Int. Cl. G06F 11/10; H04L 29/08

(52) U.S. Cl. CPC G06F 11/1076; H04L 67/1097

(57) ABSTRACT

A method and apparatus is disclosed herein for code length adaptation for access to key-value based storage systems. In one embodiment, the method comprises receiving a data object and a request; dividing the data object into K portions, where K is an integer; selecting an FEC coding rate based on backlog associated with at least one queue; applying FEC coding based on the FEC rate set to the K portions to create N FEC coded data blocks, where N is an integer greater than or equal to K; and sending the N FEC coded data blocks to the storage system.

### PRIORITY

The present patent application claims priority to and incorporates by reference the corresponding provisional patent application Ser. No. 61/733,339, titled, “A Method and Apparatus for Code Length Adaptation for Low Delay Access to Key-Value Based Cloud Storage Systems Using FEC Coding Techniques,” filed on Dec. 4, 2012.

### FIELD OF THE INVENTION

Embodiments of the present invention relate to the field of storage systems; more particularly, embodiments of the present invention relate to the use of forward error correction (FEC) in the storage and retrieval of objects in storage systems.

### BACKGROUND OF THE INVENTION

In public clouds such as Amazon's S3, the delay for a single read or write operation for small objects (e.g., less than or equal to 1 Kbyte) can be 100 s of milliseconds of delay while for medium size objects (e.g., >1 Mbyte) delays can become in the order of seconds at 99^{th} and 99.9^{th} percentiles. For cascaded operations where one transaction needs many reads and writes to the same storage facility, these delays can be unacceptably high. For video content that consists of many megabytes, how to use S3 type storage as the video archive while attaining small startup delays and no pauses for video playback also has become a critical issue.

Recently, the work “Codes Can Reduce Queueing Delay in Data Centers”, appeared in IEEE ISIT 2012, and the work “Erasure Coding in Windows Azure Storage”, appeared in USENIX ATC 2012. FIG. 1 illustrates the system proposed in these papers for read-only scenario. Every file to be read is first divided into K equal-sized blocks and encoded into N coded blocks with a (N,K) FEC code. There are N servers and every server stores one different coded block for each file. To serve a file-read request, a request dispatcher issues K read operations to the first K servers that become idle for the K coded blocks stored on these servers. These K servers are kept active until all read operations for all K coded blocks have completed, and then they become idle again and can serve other file-read requests. The dispatcher then performs FEC decoding to recover the original file from the K coded blocks. In the system, every file is coded with a fixed (N,K) FEC code. In the first paper, every request is served by the minimum number of exactly K parallel read operations (from K servers), i.e., zero overhead is introduced. In the second paper, if a request is directed to read a coded chunk stored on a hot (heavily loaded) node, in parallel, they read extra data from other servers, try to reconstruct the chunk stored on the hot node, and provide that to the client. Thus, they use FEC for storage durability/availability purposes while still trying to minimize the amount of data to be read.

In content delivery systems with network coding, in which multiple unicasting, multicasting, or broadcasting sessions compete for network capacity, a common goal is to allocate network capacity for different sessions such that certain utility function (e.g., total throughput and weighted sum of logarithmic throughput) is to be maximized. A representative picture for this is shown in FIG. 2. Referring to FIG. 2, there are two multicasting sessions: S1 to {D1,D2} (curved arrows 201 and 202) and S2 to {D3,D4} (curved arrows in 203 and 204) that compete for network capacity, in particular the capacity of link R1→R2. The utility is usually modeled as a concave function of the throughput received by each session, which is in term determined by how much link capacity is allocated for that session on every link in the communication network. The system designer has to allocate link capacities for each session so that the overall utility is maximized, and control the unicast/multicast/broadcast rate for each session so that the amount of traffic injected conforms to the allocated link capacities. In such systems, throughput is the only concern, and although coding is also used, it is used merely to achieve multicasting capacity for each session given the link capacity allocation. As a result, there is zero redundancy when using network coding.

### SUMMARY OF THE INVENTION

A method and apparatus is disclosed herein for code length adaptation for access to key-value based storage systems. In one embodiment, the method comprises receiving a data object and a request; dividing the data object into K portions, where K is an integer; selecting an FEC coding rate based on backlog associated with at least one queue; applying FEC coding based on the FEC rate set to the K portions to create N FEC coded data blocks, where N is an integer greater than or equal to K; and sending the N FEC coded data blocks to the storage system.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 illustrates a prior art storage arrangement that uses FEC to reduce queuing delay in data centers.

FIG. 2 illustrates an example of multiple multicasting sessions compete for network capacity.

FIG. 3 is a block diagram of one embodiment of a storage system.

FIG. 4 is a block diagram of one embodiment of an application executed by a store client.

FIG. 5 is a flow diagram of one embodiment of a process for request handling performed by a classifier and a scheduler.

FIG. 6 is a flow diagram of one embodiment of a process for read request handling by the request handler.

FIG. 7 is a flow diagram of one embodiment of a process for write request handling by the request handler.

FIG. 8 illustrates parallel threads that execute read/write (R/W) tasks obtain new tasks from a task queue when they are done servicing a current task.

FIG. 9 illustrates an example of thresholding F_{C}( ) functions, with two categories R (read) and W (write).

FIG. 10 is a flow diagram of one embodiment of a process for determining N_{C} given a set of thresholds.

FIG. 11 illustrates raw data in terms of delay performance for different cloud locations are stored in a database.

FIG. 12 is a flow diagram of one embodiment of a process for computing thresholds for a category C.

FIG. 13 is a flow diagram of one embodiment of a process for estimating Δ_{C} and μ_{C} in the online fashion.

FIG. 14 is a flow diagram of one embodiment of a process for storage controller such as a store client.

FIG. 15 depicts a block diagram of a storage gateway or a client device.

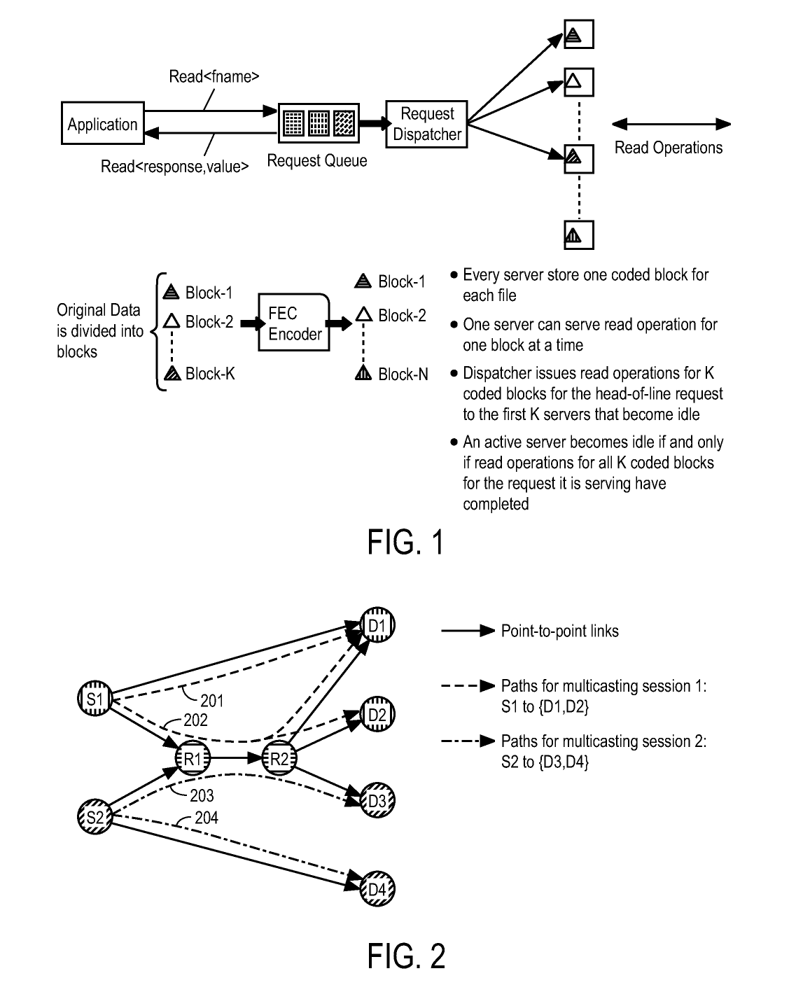

### DETAILED DESCRIPTION OF THE PRESENT INVENTION

Embodiments of the present invention include methods and apparatuses that adaptively adjust the level of code redundancy to provide robust throughput-delay tradeoff when using FEC code for delay improvement in storing and retrieving data objects including videos, images, documents, meta-data, etc. in public cloud-based storage such as, for example, Amazon S3 or in private cloud-based storage systems (potentially of different size and different delay requirements). At low system utilization level, using FEC is beneficial because the time a request being served is significantly reduced by parallelism. On the other hand, at high system utilization level, using FEC is detrimental because it creates redundant write or read requests which further increases system utilization and causes requests spending significantly more time waiting to be served. Embodiments of the present invention adapt the FEC rate (including no coding) used by different categories of requests according to the backlog size, so that the overall delay performance is optimized for all levels of system utilization as well as all possible compositions of requests arrivals.

The techniques described herein can be used by the host devices where data is produced and/or consumed as well as by proxy nodes that sits between the host devices and public storage facility. A public storage facility is accessed through using their API that opens connections between the API client (host or proxy nodes) and API server (residing in the storage facility). Through the API, clients can issue put, get, delete, copy, list, etc. requests where appropriate providing security credentials, local keys and global names to uniquely identify the objects, byte strings that represent the object, etc. Although clients are agnostic to how their requests are operationally carried out within the public cloud, they are sensitive to end to end delays incurred in resolving their requests. Measurement studies indicate that even when there is enough network bandwidth and the clients are very close to the storage nodes, there are substantial long tails in delay performance distributions with bottom 1% and 0.1% delay profiles observing much worse delays than the average performance. Measurements studies also indicate that the delay performances of parallel requests on different keys are weakly correlated.

Embodiments of the present invention use multiple categories of request and each category may use different FEC codes with different code dimension K_{C}. Requests of category C can be served by (N_{C}−K_{C}) redundant read or write operations, in addition to the minimum K_{C} ones. Moreover, in one embodiment, even within the same category C, different requests may be served by a different number of read or write operations, since N_{C} is a time varying parameter updated on a per-request basis. A feature of embodiments of the present invention is that it allows multiple categories of requests with various ranges of object sizes and delay distributions, and the amount of extra overhead for each category (governed by N_{C}) is adapted independently based on the system backlog. When the user application targets a particular delay performance (e.g., a video streaming application requiring a low delay), embodiments of the present invention select an appropriate category for that client's requests. The number of redundant read or write operations for requests of different categories are then adjusted independently to deliver the performance.

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; etc.

### Overview

Embodiments of the present invention make use of erasure coding techniques to eliminate the tail performers in key-value based storage systems. In one embodiment, requests arriving into the system are classified into different categories, where each category C is specified by a four-tuple <object size S_{C}, block size B_{C}, redundancy parameter M_{C}, type write/read>, depending on the object size (e.g., in bytes), Quality of Service (QoS) delay requirement, and whether it is a put/write request or a get/read request. In one embodiment, all requests belonging to the same category C have identical object size S_{C} (possibly after padding) and require the same type of operation (write or read). In one embodiment, they share similar QoS delay requirements as well.

Every object corresponding to a category-C request is divided into smaller objects of size BC to create an ordered set of K_{C}=S_{C}/B_{C} smaller objects. In one embodiment, for a given category C, S_{C} and B_{C} are fixed and hence K_{C} is fixed, but different categories may have different values of K_{C}. The objects starting from the smallest index value to largest are given as input blocks to an erasure encoder, where K_{C} is referred as the dimension of the code. The encoder then generates (N_{C}−K_{C}) output parity blocks of the same fixed size. In one embodiment, N_{C} is a tunable parameter determined as a function F_{C} of the number of backlogged requests Q, i.e., N_{C}=F_{C}(Q). M_{C}+1 is the maximum number of extra parity coded blocks allowed for category-C objects (i.e., N_{C}≦K_{C}+M_{C}+1). In one embodiment, N_{C} is updated every time a new request of category C arrives. Adaptation of N_{C} for different categories is done independently.

The store client stores the original K_{C} source blocks and (N_{C}−K_{C}) parity blocks separately using N_{C} ordered unique keys in a storage facility (e.g., public storage facility, private storage facility, etc.). When a store client needs to put/write or get/read the large object, it sends N_{C} parallel put/write or get/read requests using unique keys for a subset of N_{C} source blocks and/or parity blocks associated with the large object. When the store client receives K_{C} valid responses to any subset of these N_{C} requests, it considers the operation as completed. If it was a get/read request, the store client reconstructs the original K_{C} smaller objects through erasure decoding. In reconstruction, the order of keys are used to determine the order of source blocks and parity blocks in the code word generated by the erasure encoder. The erasure coding in the system is not used to increase storage reliability nor handle packet losses, but to improve the delay performance at low storage and communication overhead. The value N_{C} represents the amount of redundancy from using erasure codes and it is used to maintain a robust balance between system throughput and potential delay improvement by using erasure codes.

In one embodiment, when the earliest K_{C} responses get delayed over a dynamically or statically determined delay threshold, the store client issues a minimal number of new put/write or get/read requests for a subset of N_{C} keys that are sufficient to recover all the objects in the originally requested set.

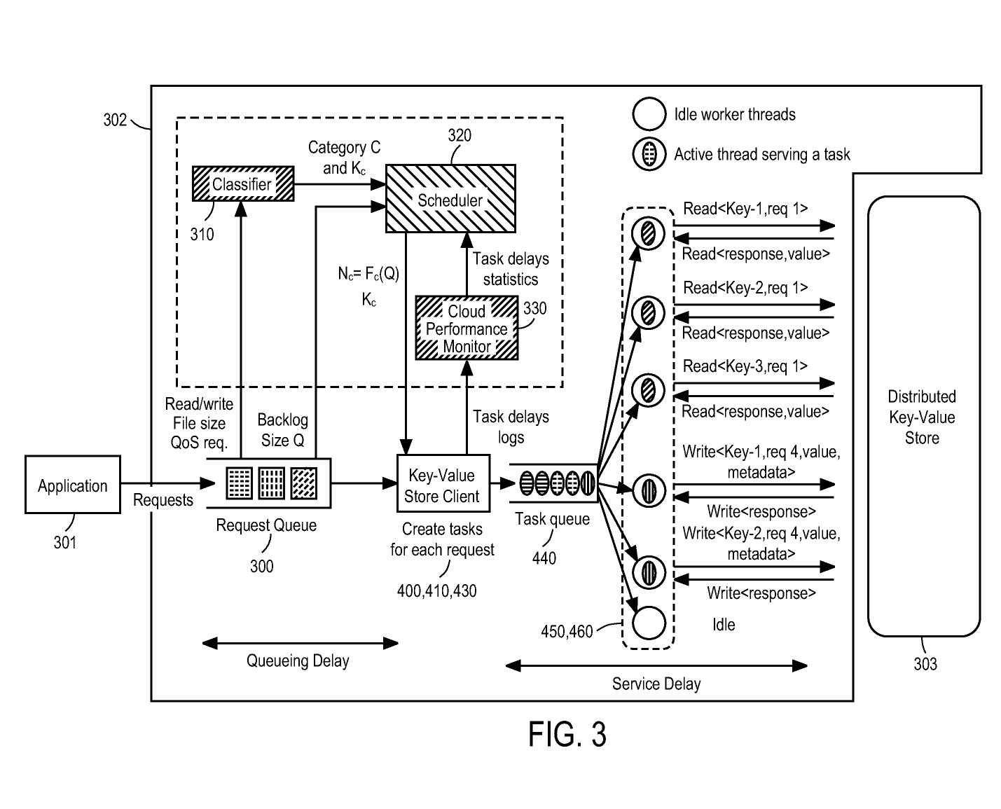

FIG. 3 is a block diagram of one embodiment of a storage system. Referring to FIG. 3, in one embodiment, there are three main components to the architecture: an application 301, a key-value store client 302, and a distributed key-value store 303.

Application 301 is the consumer of the storage system. Application 301 generates data to be stored in the backend storage (e.g., distributed key-value store 303) and downloads the data stored in the backend storage.

Key-value store client 302 interfaces application 301 with the backend storage, namely distributed key-value store 303. In one embodiment, key-value store client 302 provides an API to application 301 to receive and respond back to the requests of application 301. These requests include read and write requests and responses. In one embodiment, the read request specifies a filename and the write request specifies a filename and the data object being stored. In one embodiment, the read response specifies a read response and the data object that was requested, and the write response specifies a response indicating that the data object has or has not been successfully stored in the backend storage.

In one embodiment, key-value store client 302 uses APIs provided by the backend storage to issue subsequent requests to the backend storage in order to resolve requests from application 301 before responding back to application 301. In one embodiment, the read requests to key-value store 303 take the form Read<Key-1> and the write requests to key-value store 303 take the form Write<Key-1, value, metadata>, where Key-1 specifies the location in key-value store 303, “value” specifies the data object being written and “metadata” specifies metadata associated with the data object being stored. In one embodiment, the read responses from key-value store 303 take the form Read<response, value> and the write responses from key-value store 303 take the form Write<response>, where “response” specifies whether the operation was successfully performed, and “value” specifies the data object being read from key-value store 303. In the case of a “value” returned from or sent to key-value storage from the key-value store client, the value corresponds to the encoded version of part of the data object, e.g., one of the N coded blocks.

Note that in one embodiment, the first K keys correspond to the uncoded sequence of K blocks of a data object and (K+1)th to Nth keys correspond to parity blocks associated with a data object. Also note in one embodiment, the metadata is only read if it is not stored locally in memory or disk at key-value store client 302. As will be described in greater detail below, key-value store client 302 returns a response to application 301 after only receiving K successful read/write replies.

In one embodiment, key-value store client 302 has its own local disk and in-memory cache to store data of application 301 and to resolve requests of application 301. In one embodiment, key-value store client 302 also models the cumulative distribution function of delays for different packet ranges with and without applying FEC. In one embodiment, key-value store client 302 is also responsible for parallelization of read/write requests with the distributed storage backend.

Distributed key-value store 303 is the distributed storage backend that provides APIs and/or libraries to the store client for operations such as writing, reading, deleting, copying objects (e.g., a sequence of opaque bytes). Typical examples of such storage backends include, but are not limited to, Amazon S3, Cassandra, DynamoDB, etc. In one embodiment, key-value store 303 provides persistent, highly available and durable storage. To accomplish this, key-value store 303 uses replication where multiple copies of the same object are stored in and accessed from different physical locations. In one embodiment, for increased durability with more storage efficiency, key-value store 303 uses FEC protection within (i.e., in conjunction with data striping) or across the data objects. Such features are transparent to application 301 as well as to key-value store client 302.

In one embodiment, the processes performed by application 301 and key-value store client 302 run on the same physical machine. In another embodiment, they can be run on different physical machines and communicate directly or over a network.

Classifier 310, scheduler 320 and cloud performance monitor 330 are parts of key-value store client 302 and are used to specify how different categories of requests are handled and how to decide what FEC code (or number of parallel read/write tasks) is used for different requests to accommodate different arrival rates as well as different requests compositions.

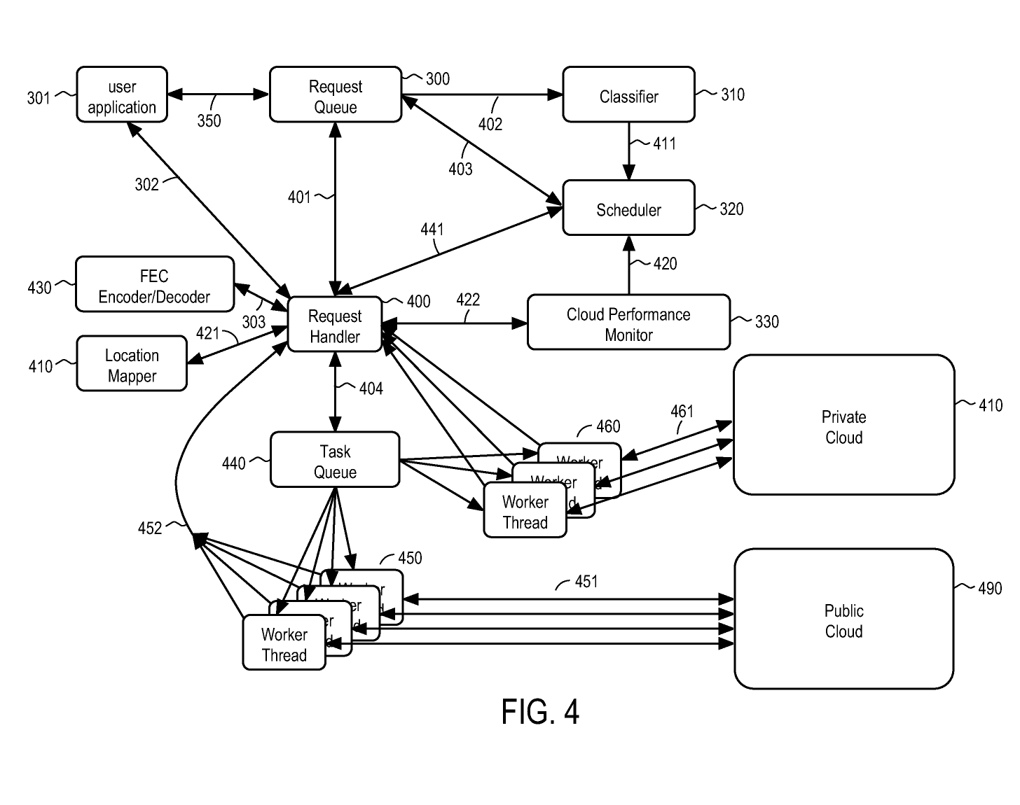

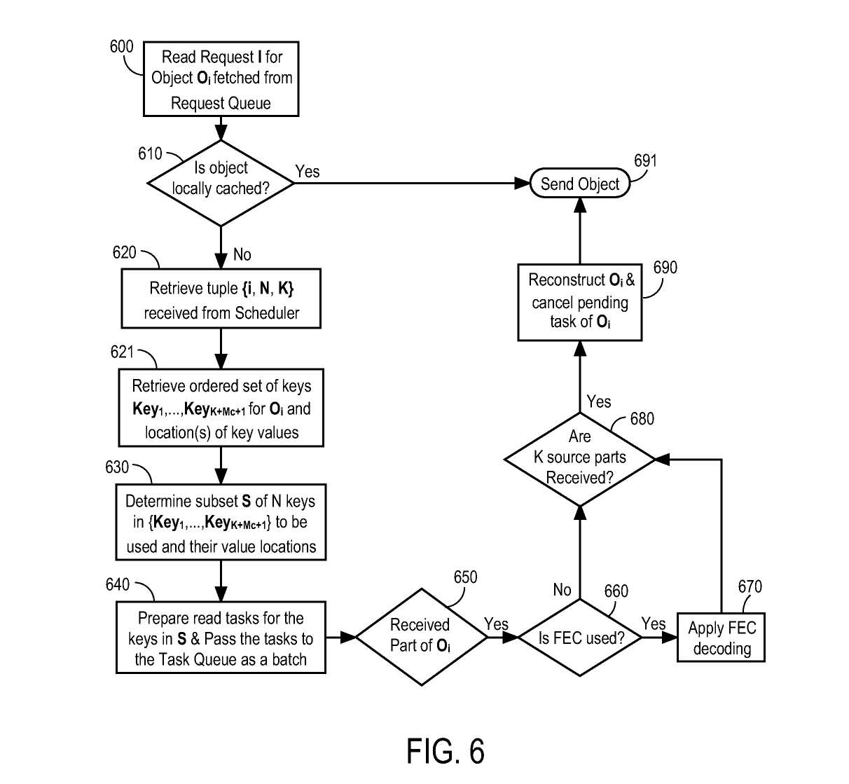

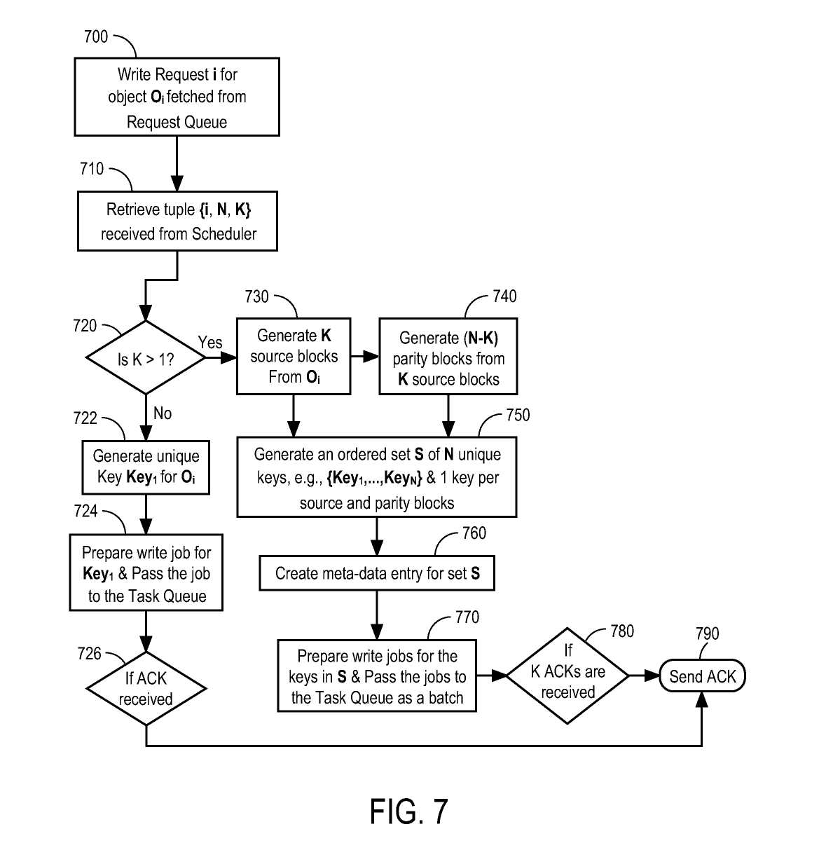

FIG. 6 is a flow diagram of one embodiment of a process for read request handling by the request handler, and FIG. 7 is a flow diagram of one embodiment of a process for write request handling by the request handler. The processes are performed by processing logic that may comprise hardware (circuitry, dedicated logic, etc.), software (such as is run on a general purpose computer system or a dedicated machine), firmware or a combination of two or more of them. The operations depicted in FIGS. 6 and 7 will be described in conjunction with FIGS. 3 and 4.

After fetching a read request through interface 401, under one set of conditions (i.e., normal conditions where no errors have been reported by the underlying cloud API), the following operations are performed:
1. Request handler 400 extracts the unique object ID of the requested object ObjID(Oᵢ) from the incoming message itself. The incoming message is stored in request queue 300 of FIG. 3. In FIG. 6, this first operation corresponds to processing block 600.
2. To determine where in the storage hierarchy the requested object is stored, request handler 400 issues a mapping service using interface 421 to location mapper 410 with the unique ID of the requested object. If the object is locally stored (e.g., in-memory cache or local disk), then request handler 400 retrieves the data from local storage (not shown in FIG. 4) and sends the object to user application 301. These operations correspond to processing blocks 610 and 691 in FIG. 6.
3. In one embodiment, if the requested object is not stored locally, request handler 400 retrieves a tuple in the form of {i,N,K} received from scheduler 320 (processing block 620 in FIG. 6). Location mapper 410 returns an ordered set of keys (Key₁, . . . , Key_{K+Mc+1}) corresponding to the object (Oᵢ) and which data store to be used per key (processing block 621 in FIG. 6). This ordered set of keys points to the source blocks and parity blocks for the requested object.
4. Request handler 400 selects any subset S of N keys in {Key1, . . . , Key_{K+Mc+1}}. This corresponds to processing block 630 in FIG. 6.
5. In one embodiment, request handler 400 prepares parallel read tasks (processing block 640 in FIG. 6), where each task is for one unique key corresponding to a source or parity block. In one embodiment, each task is self-descriptive in the sense that which cloud location should be used for the job is included in its job description. All the parallel read tasks corresponding to the same object are passed as a batch to task queue 440. In one embodiment, the jobs in a batch are not interleaved with the jobs that belong to other batches.
6. In one embodiment, interface 404 serves two purposes: (i) passing the actual tasks and (ii) passing tasks or batch attributes. In one embodiment, request handler 400 can cancel an individual task or all the tasks of a given batch by changing the task or batch attribute to “cancelled”. If the task is still in its queue, task queue 440 deletes the task. Otherwise, task queue 440 issues an abort command to the thread processing the task.
7. Each of worker threads 450 and 460 serve one task at a time and when their current task finishes (handed to request handler 400 to execute processing block 650 in FIG. 6), they ask for a new task from task queue 440. Task queue 440 hands the head of line task to the requesting worker thread. In one embodiment, worker threads 450 and 460 can access to different cloud locations using the task description. The APIs to access these different clouds can be different, and thus the location information dictates which cloud instance should be used and which API call has to be issued. If an abort command is received for an ongoing task, then the worker thread can cancel its current task, return task status to request handler 400, and request a new task.
8. If FEC is used, request handler 400 passes the source blocks and parity blocks (K in total) of a given batch to the FEC decoder 430 as they are returned by a number of worker threads. If the returned block is a source block, it is also kept by request handler 400. As it is able to recover any missing source blocks (not yet received), FEC decoder 430 passes the recovered source blocks to request handler 400 (processing blocks 660 and 670 in FIG. 6).
9. Once it receives all the source blocks of the requested object (processing blocks 680 and 690), request handler 400 sends the object Oᵢ back to user application 301 (processing block 691) using interface 302.
10. Once all the source blocks are recovered for a given batch, request handler 400 issues a cancellation request to task queue 440 for the remaining jobs of the same batch (processing block 690), thereby cancelling the remaining jobs.

After fetching a write request through interface 401, under a set of conditions (e.g., normal conditions with no errors reported by the underlying cloud API), the following operations are performed:
1. Request handler 400 extracts the unique ID i of the object (processing block 700 in FIG. 7). In one embodiment, the object is locally cached/stored.
2. In one embodiment, request handler 400 retrieves a tuple in the form of {i,N,K} received from the Scheduler (processing block 710 in FIG. 7).
3. If FEC is to be utilized (i.e., K>1), request handler 400 divides the object into K source blocks and asks FEC encoder 430 to generate N−K parity blocks (processing blocks 720, 730 & 740 of FIG. 7). If FEC is not used (i.e., K=1), then a single unique key assignment (e.g., Key₁) is made, a single write job is issued, and the success result is sent back when the write job is completed successfully are the default set of operations performed (processing blocks 722, 724, 726, 790 of FIG. 7).
4. Request handler 400 generates an ordered set S of unique keys (Key₁, . . . , Key_{N}) to label each source block and parity block to be written as part of the same write operation. In one embodiment, this meta-data is persistently stored locally as well as tagged to the write tasks (i.e., public cloud will store the meta data as well). These operations are performed as part of processing blocks 750 and 760 in FIG. 7.
5. Request handler 400 caches the excessive parity blocks and creates a new batch of tasks, where each task is a write request for a unique key in the newly generated ordered set. This batch of tasks is passed to task queue 440. These operations correspond to processing block 770 in FIG. 7. In one embodiment, the jobs in a batch are not interleaved with the jobs that belong to other batches. The jobs can be interleaved if they are demoted to “background job” status.
6. In one embodiment, request handler 400 demotes an individual job or all the jobs of a given batch by changing the job or batch attribute to “background job”, and then, higher priority jobs can be moved in front of these background jobs. Jobs of different batches that are demoted to background traffic are processed on a first come first serve basis. The change of attribute is done through the interface 404.
7. In one embodiment, worker threads 450 and 460 serve one task at a time and when their current task finishes, they ask for a new task from task queue 440. Task queue 440 hands the head of line task to the requesting worker thread. Worker threads 450 and 460 can access to different cloud locations using the task description. The APIs to access these different clouds can be different, thus location information dictates which cloud instance should be used and which API call has to be issued.
8. Request handler 400 listens to the number of successful write responses (e.g., ACKs or Acknowledgements) from worker threads 450 and 460 of a given batch. After receiving sufficient number (K) of successful write responses (i.e., ACKs), request handler 400 sends a success response (e.g., ACK) back to user application 301 that originally issued the write request. These operations correspond to processing blocks 780 and 790 of FIG. 7. In one embodiment, request handler 400 demotes the remaining jobs in the same batch to background status by changing the job attributes through interface 404.

In one embodiment, with respective to adapting the FEC coding, request queue 400, classifier 310, schedule 320 and cloud performance monitor 330 are involved in the following process:
User application 301 is the consumer of the storage system. It generates data to be stored in the backend storage and it downloads the data stored in the backend storage.
In one embodiment, request queue 300 is the module that buffers read or write requests received from the application but have not been processed by the key-value store client yet. Request queue 300 provides API to classifier 310 to pull meta information of requests, such as, for example, the type of operation (get/read or put/write), object/file size, QoS requirement, etc. Request queue 300 also provides API to scheduler 320 to pull system backlog information. In one embodiment, the system backlog information includes an instantaneous number of requests waiting in request queue 300, or a moving average of the number of requests waiting in request queue 300 upon the 10 most recent request arrivals.
In one embodiment, classifier 410 is the module that assigns requests to corresponding categories, depending on the object size (e.g., in bytes), Quality of Service (QoS) delay requirement, and whether it is a put/write request or a get/read request. In one embodiment, each category C is specified by a four-tuple <Object size S_{C}, Block size B_{C}, Redundancy parameter M_{C}, Type write/read>. Once a request is assigned to category C, C and the corresponding parameter K_{C} is passed to scheduler 320. Parameter M_{C} captures the amount of extra storage and communication cost allowed for category-C requests: M_{C}+1 is the maximum number of extra parity blocks available for category-C objects. The larger M_{C} is, the more parallel tasks can be created for a request and hence it is more likely to receive lower delay. For this reason, in one embodiment, requests with lower delay requirements are assigned to categories with larger value of M_{C}.
In one embodiment, scheduler 320 is the module that determines the value of N_{C} for each request based on (1) category C the request belongs to, (2) backlog information provided by request queue 300, and (3) delay statistics provided by cloud performance monitor 330. In one embodiment, scheduler 320 then passes the tuple {N_{C},K_{C}} to the request handler. In one embodiment, the backlog information of request queue 300, denoted as Q, is the instantaneous backlog size, i.e., the number of requests waiting in request queue 300. In another embodiment, Q is a moving average of the number of backlog size.
In one embodiment, cloud performance monitor (CPM) 330 is a process that collects logs of delays for tasks belonging to different categories through API provided by the key-value store client. CPM 330 processes these logs to provide statistics for delay performance of different task types and object sizes, which are used to during the procedure of determining N_{C}. In one embodiment, the statistics CPM 330 provides are the mean and standard deviation of the collected delays of task of each category. In another embodiment, the delay of each category is associated with a statistical model determined in advance. This may be done in a manner well-known in the art. One way to construct such a model is to gather delay measurements and look into the CDF. Then a delay model may be selected manually. For example, the delay can be modeled as a non-negative fixed constant Δ plus an exponential random variable X. Another way to generate the model may be to use data mining techniques. In one embodiment, CPM 330 computes model parameters that fit the collected delays best (possibly using machine learning techniques) and provides these model parameters to scheduler 320 as delay statistics. In another embodiment, no statistical model is given a priori and instead data mining techniques are used to discover structure in the logged delays and provide the models on-the-fly. In one embodiment, key-value store client 302, including request queue 300, classifier 310, scheduler 320, and CPM 330, interfaces user application 301 with the backend storage. In one embodiment, the key-value store client provides an API to user application 301 to receive and respond back to requests of user application 301. According to the tuple {N_{C}, K_{C}} received from scheduler 320, key-value store client 302 creates subsequent read or write requests for smaller objects using FEC. For purposes herein, such requests are referred to as tasks in order to distinguish them from the original requests issued by user application 301. In one embodiment, tasks are served by worker threads 450 and 460 in order to resolve requests from user application 301. Then key-value store client 302 responds back to user application 301. In one embodiment, key-value store client 302 has its own local disk and in-memory cache to store data of user application 301 and to resolve requests of user application 301. In one embodiment, key-value store client 302 is responsible for parallelization of read/write requests with the distributed storage backend. In one embodiment, key-value store client 302 is also responsible of collecting delays for tasks belonging to different categories and provides delay statistics to CPM 330 through the corresponding API.
In one embodiment, worker threads 450 and 460 are the units that carry out read or write tasks with the backend storage using the provided APIs. In one embodiment, each thread can read or write one object from or to the backend storage system at a time. A thread is active if it is in the processing of serving a read or write operation with the backend storage and waiting for the response. Otherwise, the thread is not serving any task and is said to be idle. Also, if K_{C} tasks for the same category-C request have been completed, any on-going task for the same request can be terminated preemptively and the corresponding thread becomes idle. Once a read or write operation is completed, the thread passes the response to key-value store client 302.
In one embodiment, task queue 440 is a module that buffers read or write tasks generated by key-value store client 302 but have not been served by any of worker threads 450 and 460 yet.
In one embodiment, distributed key-value store 303 (e.g., private cloud 470, public cloud 490, etc.) is a distributed storage backend that provides APIs and/or libraries to the store client for operations such as writing, reading, deleting, copying objects (e.g., a sequence of opaque bytes). In one embodiment, key-value store 303 provides persistent, highly available and durable storage. To accomplish this, it uses replication where multiple copies of the same object are stored in and accessed from different physical locations. For increased durability with more storage efficiency, the store itself can use FEC protection within (i.e., in conjunction with data striping) or across the data objects. Such features are transparent to the application as well as to key-value store client 302 disclosed in this invention.

In one embodiment, all components except for distributed key-value store 303 run on the same physical machine. In another embodiment, they can be run on different physical machines and communicate over a network.

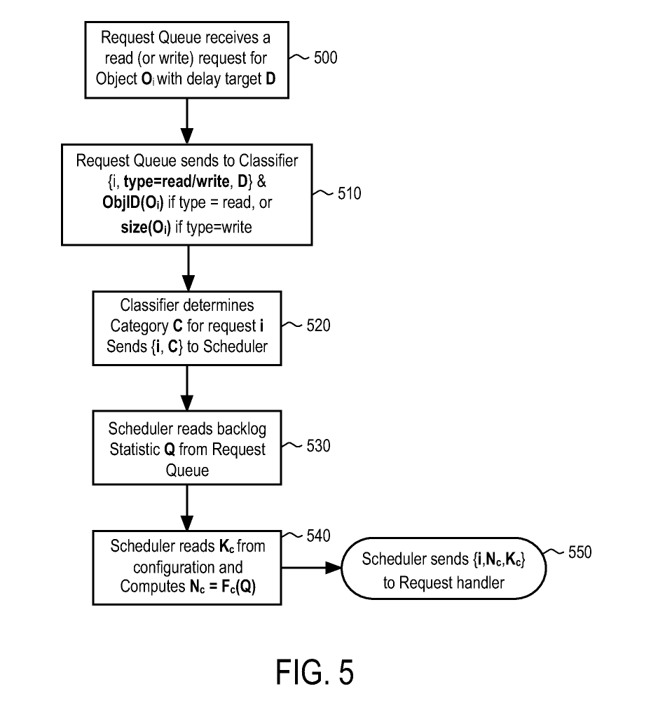

In one embodiment, key-value store client 302 assigns categories to application requests and determining the FEC code used to serve each application request. FIG. 5 is a flow diagram of one embodiment of a process for request handling performed by a classifier and a scheduler. The process in FIG. 5 is performed by processing logic that may comprise hardware (circuitry, dedicated logic, etc.), software (such as is run on a general purpose computer system or a dedicated machine), firmware, or a combination of them.

After receiving a read (or write) request through interface 350, under one set of conditions (e.g., normal conditions with no error reported by the underlying cloud API), the following operations are performed:
1. Request queue 300 extracts the unique request ID i, type of operation (read or write) and delay target D of the object from the incoming request. This information is then sent to classifier 310 through interface 402. If the type of operation is read, request queue 300 also extracts the unique object ID ObjID(Oᵢ) and sends it to classifier 310. If the type of operation is write, request queue 300 also sends the size of the object size(Oᵢ) to classifier 310. In FIG. 5, these operations correspond to processing blocks 500 and 510.
2. Classifier 310 determines which category C the request for object Oᵢ belongs to. If the request is to read the object, Oᵢ should have already been stored in the system with unique object id ObjID(Oᵢ), category C is chosen such that it matches the way Oᵢ is stored in the system (i.e., matching S_{C}, B_{C}, M_{C}). If the request is to write the object, then classifier 310 picks a category C such that S_{C}≧size(Oᵢ). Once the category C is decided, classifier 310 passes a tuple {request id i, category C} to Scheduler (220) through interface 411. In FIG. 5, this operation corresponds to processing block 520.
3. Upon receiving a tuple {request id i, category C}, scheduler 320 requests the queue backlog statistic information Q from request queue 300 using interface 403. In one embodiment, Q can be the instantaneous backlog size, i.e. the number of requests buffered in request queue 300. In another embodiment, Q can be a moving average of the backlog size. In another embodiment, Q can be a vector specifying the number of read and write requests of different object sizes. Then scheduler 320 computes N_{C}=F_{C}(Q), where F_{C}( ) is a function specified for category C that maps Q into an integer between (and including) K_{C} and K_{C}+M_{C}+1.
4. Then scheduler 320 passes a tuple {request id i, N_{C}, K_{C}} to request handler 400 using interface 441. These method steps correspond to processing blocks 530, 540 and 550 in FIG. 5.

In one embodiment, one implementation of F_{C} is thresholding: each category C is associated with a set of M_{C}+1 thresholds {T_{C,0}, T_{C,1}> . . . >T_{C,Mc}} such that T_{C,0}>T_{C,1}> . . . >T_{C,Mc}>0. Q is the backlog size (e.g. instantaneous or moving averaged). Then F_{C}(Q) equals
K_{C}, if Q>T_{C,0};
K_{C}+1, if T_{C,0}≧Q>T_{C,1};
. . .
K_{C}+M_{C}, if T_{C,Mc-i}≧Q>T_{C,Mc};
K_{C}+M_{C}+1, if Q≧T_{C,Mc}.

FIG. 9 illustrates an example of the thresholding F_{C}( ) functions, with two categories R (read) and W (write). N_{R} is decided based on which range between the thresholds {T_{R,i}} Q falls into. Similar for N_{W} with thresholds {T_{W,i}}.

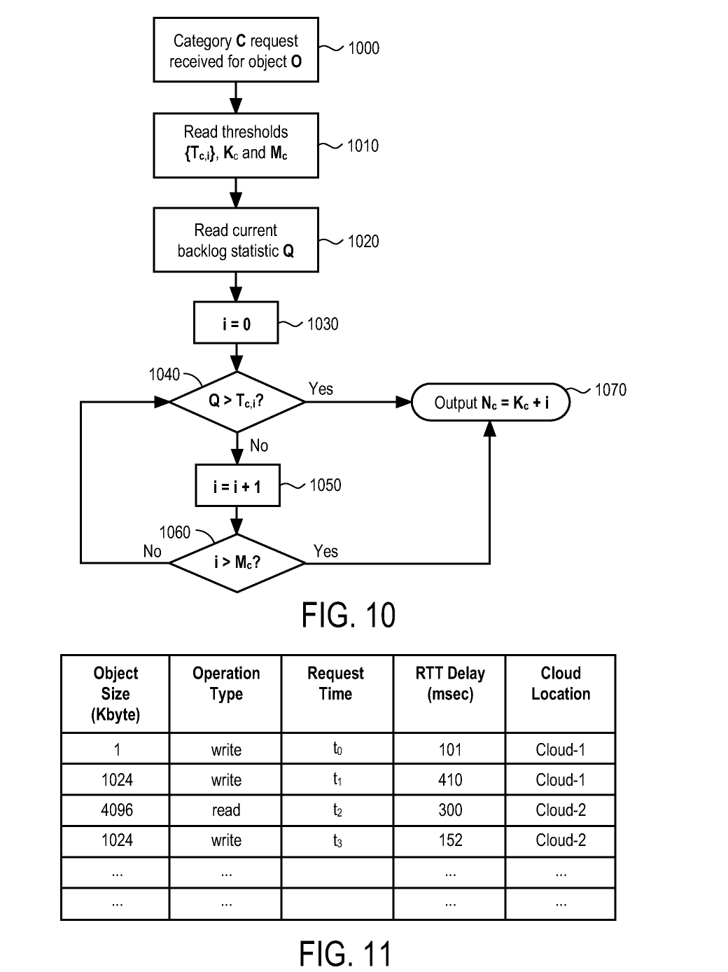

FIG. 10 is a flow diagram of one embodiment of a process for deciding N_{C} given a set of M_{C}+1 thresholds as described above. The process in FIG. 10 is performed by processing logic that may comprise hardware (circuitry, dedicated logic, etc.), software (such as is run on a general purpose computer system or a dedicated machine), or a combination of both.

Referring to FIG. 10, upon receiving the information of a category-C request for object O from classifier 310 (processing block 1000), scheduler 320 reads the set of thresholds {T_{C,0}, . . . T_{C,Mc}} and M_{C} associated with category C (processing block 1010). Scheduler 320 also read the latest backlog statistic Q from request queue 300 (processing block 1020).

Scheduler 320 then starts to compare Q with the thresholds in an increasing order of i=0, . . . , M_{C}+1 (processing blocks 1030, 1040, 1050 and 1060). As soon as the first i≦M_{C} such that Q>T_{C,i} is found or i becomes M_{C}+1, it decides N_{C}=K_{C}+i (processing block 1070).

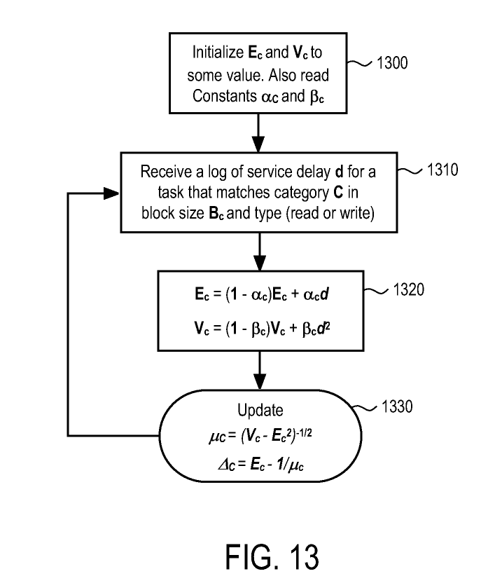

For achieving good delay-throughput performance, the choice of F_{C}( ) functions is crucial. Cloud Performance Monitor 330, referred to as CPM 330, provides information to scheduler 320 for determining and adjusting F_{C}( ) for each category according to delay statistics it collects from request handler 400. In one embodiment, worker threads 450 and 460 create a log for successfully completed tasks with information on object size, task type (read or write), sending time, cloud location, and round trip time delay (i.e., from the time the job is scheduled until the time a successful response is received). FIG. 11 shows how CPM logs this information in a table that is stored in a database. CPM 330 processes these logs to provide statistics for delay performance of different task types and object sizes, which are used to for determining F_{C}( ) functions. For example, the processing can be computing the mean and standard deviation of the delay for each task type and object size. This is in fact what was done in the example of FIG. 13. In one embodiment, the thresholds for the thresholding F_{C}( ) functions described above are found in the following way. The per-task round trip time delay for each category C is model by a random variable in the form of Δ_{C}+X_{C}, where Δ_{C} is a nonnegative constant and X_{C} is an exponentially distributed random variable with mean 1/μ_{C}. Suppose only requests of category C arrives and the arrival follows a Poisson process of rate λ. Assume that N_{C}=K_{C}+i is fixed, and there are L parallel worker threads (450 and 460) in the system. Also assume that request handler 400 fetches a request from request queue 300 if and only if task queue 440 becomes empty and at least one of worker threads 450 and 460 is idle. Denote the expected time a request spends in request queue 300 as D_{i,queue}(λ), and the time between a request is fetched by request handler 400 and it is completed and responded to the application as D_{i,service}. These two quantities can be approximated by

$${D}_{i , queueing} ( λ ) = \frac{λ ( {N}_{C} + 1 )}{2 {N}_{C} {T}_{i} ( {T}_{i} - λ )} \\ {D}_{i , service} = {Δ}_{C} + {\sum }_{j = {N}_{C} - {K}_{C} + 1}^{{N}_{C}} \frac{1}{j {μ}_{C}} \qquad ( E01 )$$

where Tᵢ=L/(N_{C}Δ_{C}+K_{C}/μ_{C}). The total delay D_{i,total}(λ)=D_{i,queue}(λ)+D_{i,service}.

Then λᵢ is solved for so that the equation D_{i,total}(λᵢ)=D_{i+1,total}(λᵢ) for i=0, . . . , M_{C}. This is equivalent to solving the following quadratic equation of 2:

$$\frac{( {N}_{C} + 1 ) {( {N}_{C} {Δ}_{C} + \frac{{K}_{C}}{{μ}_{C}} )}^{2}}{2 {N}_{C} L} λ ( L - λ ( ( {N}_{C} + 1 ) {Δ}_{C} + \frac{{K}_{C}}{{μ}_{C}} ) ) + \frac{( L - λ ( {N}_{C} {Δ}_{C} + \frac{{K}_{C}}{{μ}_{C}} ) ) ( L - λ ( ( {N}_{C} + 1 ) {Δ}_{C} + \frac{{K}_{C}}{{μ}_{C}} ) )}{( {N}_{C} - {K}_{C} + 1 ) {μ}_{C}} = \frac{( {N}_{C} + 2 ) {( ( {N}_{C} + 1 ) {Δ}_{C} + \frac{{K}_{C}}{{μ}_{C}} )}^{2}}{2 ( {N}_{C} + 1 ) L} λ ( L - λ ( {N}_{C} {Δ}_{C} + \frac{{K}_{C}}{{μ}_{C}} ) ) + \frac{( L - λ ( {N}_{C} {Δ}_{C} + \frac{{K}_{C}}{{μ}_{C}} ) ) ( L - λ ( ( {N}_{C} + 1 ) {Δ}_{C} + \frac{{K}_{C}}{{μ}_{C}} ) )}{( {N}_{C} + 1 ) {μ}_{C}} \qquad ( E02 )$$

Since this is a quadratic equation of single unknown, there is closed form solution for the roots. The smaller root is taken as λᵢ. In one embodiment, λᵢ is the threshold of the arrival rate 2 above which N_{C}=K_{C}+i produce a smaller total delay than N_{C}=K_{C}+i+1 and below which N_{C}=K_{C}+i+1 has a smaller total delay.

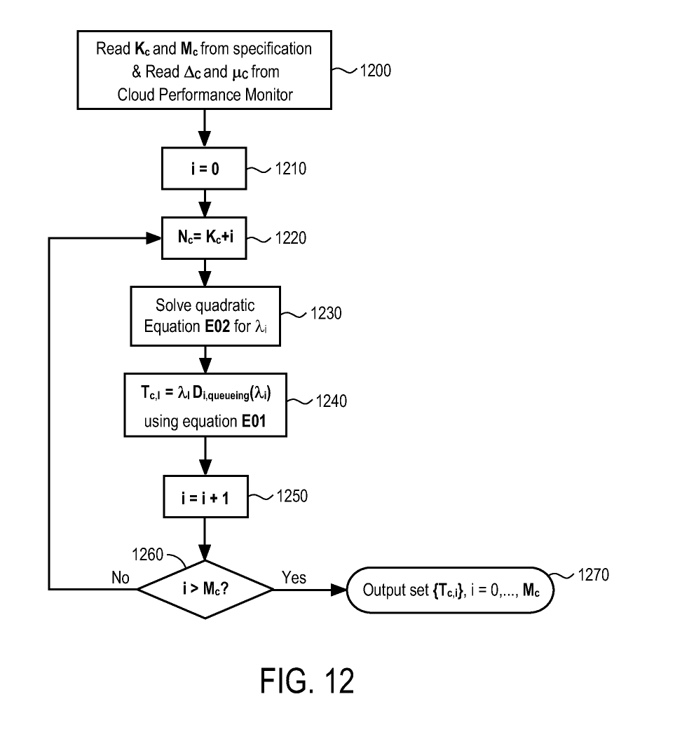

FIG. 12 is a flow diagram of one embodiment for computing the set of thresholds for F_{C}( ) according to the above description. The process is performed by processing logic that may comprise hardware (circuitry, dedicated logic, etc.), software (such as is run on a general purpose computer system or a dedicated machine), or a combination of both.

Referring to FIG. 12, CPM 330 first reads the values of K_{C} and M_{C} from specification of category C as well as estimates of Δ_{C} and μ_{C} computed from logs gathered from worker threads. This first step corresponds to block 1200 in FIG. 12.

For i=0, . . . , M_{C}, CPM 330 solves the quadratic equation E02 for λᵢ. For every λᵢ obtained, set threshold T_{C,i}=λᵢ D_{i,queueing}(λᵢ), where _{Di,queueing}(λᵢ) is computed according to equation E01. These method operations correspond to processing blocks 1210, 1220, 1230, 1240, 1250 and 1260 in FIG. 12.

Once all M_{C}+1 thresholds are computed, update the set of thresholds {T_{C,0}, . . . , T_{C,Mc}} for category C (processing block 1270).

In one embodiment, in order to determine the F_{C}( ) functions, CPM 330 requires knowledge of statistics of delay performance of the cloud storage systems. In one embodiment, delay performance statistics are collected in offline measurements a priori. In this is the case, F_{C}( ) functions are determined a priori and used statically throughout the execution of the system. In another embodiment, delay statistics of the cloud storage systems are collected online and get updated every time a worker thread finishes serving one task and produces a new log entry accordingly. In this case, CPM 330 needs to recompute F_{C}( ) functions once in a while in order to keep track of the variation in performance of the cloud storage system. Given that performance of the cloud storage system may change over time unpredictably, the online approach is preferred.

FIG. 13 is a flow diagram of one embodiment of a process for performing online estimation of Δ_{C} and μ_{C} for the thresholding F_{C}( ) described earlier, using exponential moving averaging. The process is performed by processing logic that may comprise hardware (circuitry, dedicated logic, etc.), software (such as is run on a general purpose computer system or a dedicated machine), or a combination of both.

Referring to FIG. 13, at the start of the system, processing logic initializes two variables E_{C} and V_{C} to some nonnegative values. Also processing logic reads constants α_{C} and β_{C} from system configuration. Both α_{C} and β_{C} from are in range [0,1]. This initial operation corresponds to processing block 1300 in FIG. 13.

Every time a new log entry is received from a worker thread of an object that matches the block size B_{C} and type of operation (read or write) for category C, processing logic reads the round trip time delay d of that entry. This operation corresponds to block 1310 in FIG. 13.

Processing logic updates E_{C} and V_{C} using equations E_{C}=(1−α_{C})E_{C}+α_{C} d and VC=(1−β_{C})V_{C}+β_{C}d². This operation corresponds to block 1320 in FIG. 13.

Processing logic updates μ_{C}=(V_{C}−E_{C}²)−½ and Δ_{C}=E_{C}−1/μ_{C}. This operation corresponds to block 1330 in FIG. 13.

In one embodiment, request queue 300 comprises a first input first output (FIFO) queue, where the read or write requests are buffered. In another embodiment, it can be implemented as a priority queue, in which requests with lower delay requirement are given strict priority and placed at the head of the request queue. The head of the line request is removed from request queue 300 and transferred to request handler 400 through interface 401, when a “fetch request” message is received from request handler 400. It is up to request handler 400 to decide when to fetch a request from request queue 300. In one embodiment, the preference is to fetch when task queue 440 becomes empty and at least one worker thread (450 and 460) is idle. When fetched, request queue 300 transfers the head of the line request to request handler 400 using interface 401 and removes it from the queue.

After fetching a request from request queue 300, request handler 400 looks up a tuple in the form of {i,N,K} received from scheduler 320. If the request is to read an object, this information specifies that the requested object has been divided into K source blocks and at least N−K parity blocks have been generated. Then request handler 400 creates N read tasks, each for reading one of the source or parity blocks corresponding to the requested object. These tasks are then inserted into task queue 440. If the request is to write an object, request handler 400 divided the object into K source blocks and generates N−K parity blocks. Then request handler 400 creates N write tasks, each for writing one of the source or parity blocks to the cloud storage system. These tasks are then inserted into task queue 440. As soon as any K of these tasks have completed, the original request is considered completed and request handler 400 sends a success response (e.g., ACK) to the application using interface 302. In the case the request is to read, the response contains the requested object obtained from FEC decoder 430. Details of how request handler 400 serves read and write requests is given above.

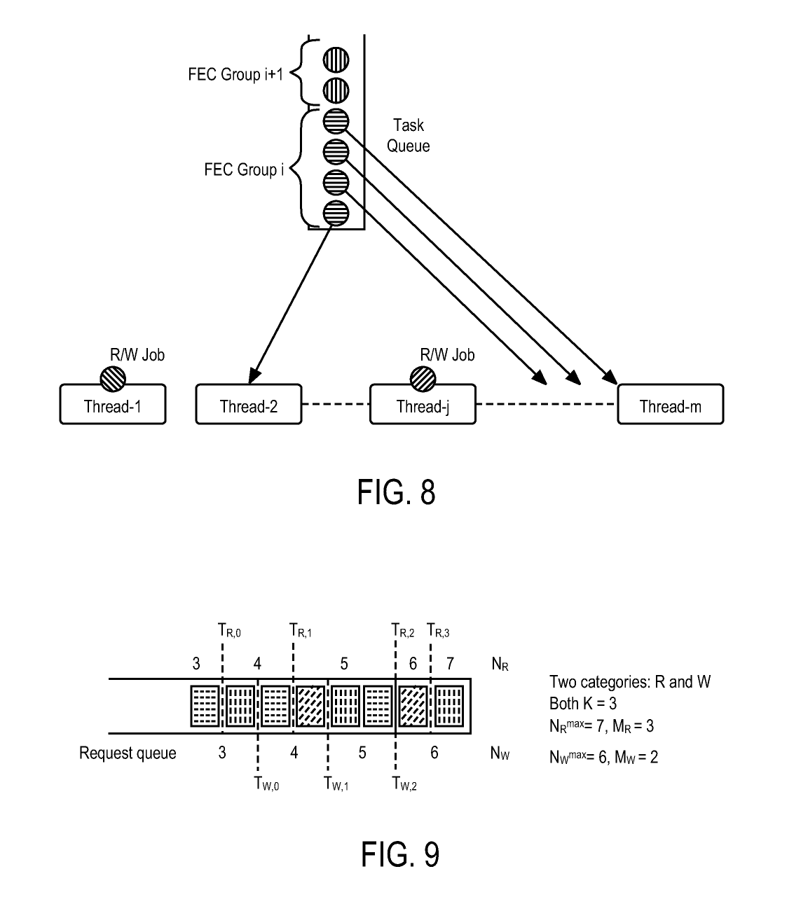

In one embodiment, task queue 440 comprises a first input first output (FIFO) queue, where the read or write task that belong to the same the application request are put in one batch with no interleaving with jobs that belong to the other FEC batches. Individual worker threads serve one task at a time and when any thread becomes idle, it gets the task waiting at the head of the task queue. FIG. 8 depicts these parallel threads that execute read/write tasks and obtain new tasks from task queue 440 when they are not servicing the current task. When there is congestion, i.e., there are more tasks waiting in the task queue than the idle threads, the delay performance worsens. For that reason, in another embodiment, requests with lower delay requirement (e.g., which use lower rate FEC codes) are given strict priority and placed at the head of task queue 440. In another embodiment, some threads can be pooled together to serve only the high priority jobs or can be used in preemptive mode (i.e., low priority job is stopped or cancelled to serve the high priority job).

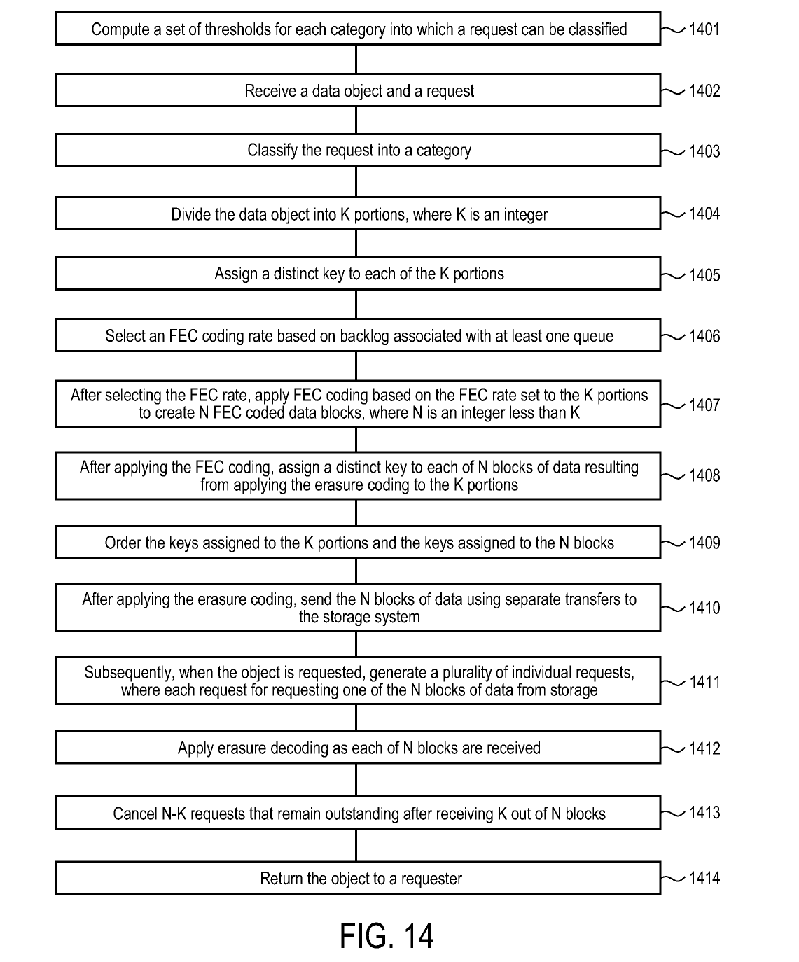

FIG. 14 is a flow diagram of one embodiment of a process for storage controller such as a store client. The process is performed by processing logic that may comprise hardware (circuitry, dedicated logic, etc.), software (such as is run on a general purpose computer system or a dedicated machine), or a combination of both.

Referring to FIG. 14, the process begins by computing a set of thresholds for each category into which a request can be classified (processing block 1401). In one embodiment, the thresholds are based on a model of delay statistics of different types of portions of data objects.

Thereafter, processing logic receives a data object and a request (processing block 1402).

Processing logic classifies the request into a category (processing block 1403). In one embodiment, classifying the request into the category is based on whether the request is for a write operation or a read operation, file size of the object, and size of the K portions.

Processing logic also divides the data object into K portions, where K is an integer (processing block 1404) and assigns a distinct key to each of the K portions (processing block 1405)

Process logic then selects an FEC coding rate based on backlog associated with at least one queue (processing block 1406). In one embodiment, the at least one queue comprises a first queue into which requests to the key-value based storage are received. In one embodiment, selecting the FEC coding rate is based on the object's size. In one embodiment, selecting an FEC coding rate is based on Quality of Service (QOS) requirements associated with the request.

In one embodiment, selecting the FEC coding rate comprises selecting N based on the category. In one embodiment, selecting the FEC rate comprises comparing a backlog statistic to one or more thresholds in the set of thresholds to determine N.

In one embodiment, N has been computed as a function of a backlog statistic. In one embodiment, the backlog statistic is based on a number of download and upload jobs waiting to be started for at least one category. In one embodiment, the backlog statistic is based on a total number of download and upload jobs waiting to be started for all categories into which requests can be classified.

After selecting the FEC rate, processing logic applies FEC coding based on the FEC rate set to the K portions to create N FEC coded data blocks, where N is an integer greater than or equal to K (processing block 1407).

After applying the FEC coding, processing logic assigns a distinct key to each of N blocks of data resulting from applying the erasure coding to the K portions (processing block 1408) and orders the keys assigned to the K portions and the keys assigned to the N blocks (processing block 1409).

After applying the erasure coding, processing logic sends the N blocks of data using separate transfers to the storage system (processing block 1410). In one embodiment, sending the N blocks of data over distinct connections to the storage system comprises sending at least two of the N blocks in parallel over two of the distinct connections.

In one embodiment, sending the N blocks of data using N separate transfers to the storage system comprises sending all N blocks in parallel on separate connections to the key-value store, including cancelling any of the N separate transfers that haven't been completed successfully after K of the N separate transfers have completed successfully.

Subsequently, when the object is requested, processing logic generates a plurality of individual requests, where each request for requesting one of the N blocks of data from storage (processing block 1411), applies erasure decoding as each of N blocks are received (processing block 1412), cancels N−K requests that remain outstanding after receiving K out of N blocks (processing block 1413), and returns the object to a requester (processing block 1414).

### An Example of a System

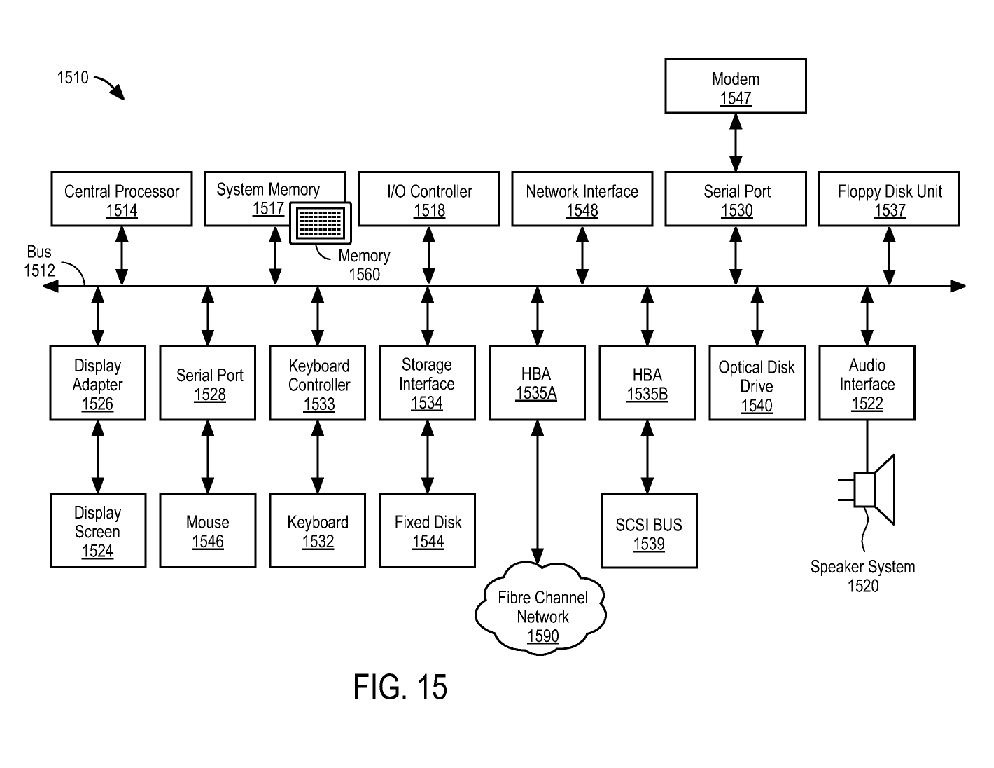

FIG. 15 depicts a block diagram of a storage gateway that may be used to access a backend storage system, such as a cloud-based storage system. Such access to the backend storage system may be over a network (e.g., wide-area network, local area network, internet, etc.). As a storage gateway, the system can interface clients running user applications to backend storage systems. Such client may be coupled directly to the storage gateway or may communicate with the storage gateway over a network (e.g., wide-area network, local area network, internet, etc.). Note that the system depicted in FIG. 15 may also be a client device that performed the operations described above or interacts with a storage gateway to read or write data objects.

In one embodiment, the storage gateway of FIG. 15 executes and performs the operations associated with the application of show in FIG. 4.

Referring to FIG. 15, storage gateway 1510 includes a bus 1512 to interconnect subsystems of storage gateway 1510, such as a processor 1514, a system memory 1517 (e.g., RAM, ROM, etc.), an input/output controller 1518, an external device, such as a display screen 1524 via display adapter 1526, serial ports 1528 and 1530, a keyboard 1532 (interfaced with a keyboard controller 1533), a storage interface 1534, a floppy disk drive 1537 operative to receive a floppy disk 1538, a host bus adapter (HBA) interface card 1535A operative to connect with a Fibre Channel network 1590, a host bus adapter (HBA) interface card 1535B operative to connect to a SCSI bus 1539, and an optical disk drive 1540. Also included are a mouse 1546 (or other point-and-click device, coupled to bus 1512 via serial port 1528), a modem 1547 (coupled to bus 1512 via serial port 1530), and a network interface 1548 (coupled directly to bus 1512).

Bus 1512 allows data communication between central processor 1514 and system memory 1517. System memory 1517 (e.g., RAM) may be generally the main memory into which the operating system and application programs are loaded. The ROM or flash memory can contain, among other code, the Basic Input-Output system (BIOS) which controls basic hardware operation such as the interaction with peripheral components. Applications resident with computer system 1510 are generally stored on and accessed via a computer readable medium, such as a hard disk drive (e.g., fixed disk 1544), an optical drive (e.g., optical drive 1540), a floppy disk unit 1537, or other storage medium.

Storage interface 1534, as with the other storage interfaces of computer system 1510, can connect to a standard computer readable medium for storage and/or retrieval of information, such as a fixed disk drive 1544. Fixed disk drive 1544 may be a part of computer system 1510 or may be separate and accessed through other interface systems.

Modem 1547 may provide a direct connection to a backend storage system or a client via a telephone link or to the Internet via an internet service provider (ISP). Network interface 1548 may provide a direct connection to a backend storage system and/or a client. Network interface 1548 may provide a direct connection to a backend storage system and/or a client via a direct network link to the Internet via a POP (point of presence). Network interface 1548 may provide such connection using wireless techniques, including digital cellular telephone connection, a packet connection, digital satellite data connection or the like.

Many other devices or subsystems (not shown) may be connected in a similar manner (e.g., document scanners, digital cameras and so on). Conversely, all of the devices shown in FIG. 15 need not be present to practice the techniques described herein. The devices and subsystems can be interconnected in different ways from that shown in FIG. 15. The operation of a computer system such as that shown in FIG. 15 is readily known in the art and is not discussed in detail in this application.

Code to implement the storage gateway operations described herein can be stored in computer-readable storage media such as one or more of system memory 1517, fixed disk 1544, optical disk 1542, or floppy disk 1538. The operating system provided on computer system 1510 may be MS-DOS®, MS-WINDOWS®, OS/2®, UNIX®, Linux®, or another known operating system.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

We claim:

1. A method for use in a key-value based storage system, the method comprising:
receiving a data object and a request;
dividing the data object into K portions, where K is an integer;
selecting an FEC coding rate based on backlog associated with at least one queue;
applying FEC coding based on the FEC rate set to the K portions to create N FEC coded data blocks, where N is an integer greater than or equal to K; and
sending the N FEC coded data blocks to the storage system.

2. The method defined in claim 1 wherein the at least one queue comprises a first queue into which requests to the key-value based storage are received.

3. The method defined in claim 1 wherein selecting the FEC coding rate is based on the object's size.

4. The method defined in claim 1 wherein selecting an FEC coding rate is based on Quality of Service (QOS) requirements associated with the request.

5. The method defined in claim 1 further comprising classifying the request into a category, and wherein selecting the FEC coding rate comprises selecting N based on the category.

6. The method defined in claim 5 wherein classifying the request into the category is based on whether the request is for a write operation or a read operation, file size of the object, and size of the K portions.

7. The method defined in claim 5 wherein N has been computed as a function of at least one backlog statistic.

8. The method defined in claim 7 wherein the at least one backlog statistic is based on a number of download and upload jobs waiting to be started for at least one category.

9. The method defined in claim 8 wherein the at least one backlog statistic is based on a total number of download and upload jobs waiting to be started for all categories into which requests can be classified.

10. The method defined in claim 6 further comprising computing a set of thresholds for each category into which a request can be classified and comparing a backlog statistic to one or more thresholds in the set of thresholds to determine N.

11. The method defined in claim 10 wherein the thresholds are based on a model of delay statistics of different types of portions of data objects.

12. The method defined in claim 1 further comprising:
assigning a distinct key to each of the K portions;
assigning a distinct key to each of N blocks of data resulting from applying the erasure coding to the K portions;
ordering the keys assigned to the K portions and the keys assigned to the N blocks; and
wherein sending the N blocks of data using N separate transfers to the storage system comprises sending all N blocks in parallel on separate connections to the key-value store, including cancelling any of the N separate transfers that haven't been completed successfully after K of the N separate transfers have completed successfully.

13. The method defined in claim 1 further comprising:
generating a plurality of individual requests, each request for requesting one of the N blocks of data from storage;
applying erasure decoding as each of N blocks are received;
cancelling N−K requests that remain outstanding after receiving K out of N blocks; and
returning the object to a requester.

14. An apparatus for use in a key-value based storage system, the apparatus comprising:
a communication interface for coupling to a network, the communication interface operable to receive a data object and a request from the network;
a memory coupled to the communication interface to store the data object and the request; and
a processor coupled to the memory and the communication interface, the processor operable to
divide the data object into K portions, where K is an integer;
select an FEC coding rate based on backlog associated with at least one queue in the memory;
apply FEC coding based on the FEC rate set to the K portions to create N FEC coded data blocks, where N is an integer greater than or equal to K; and
send the N FEC coded data blocks to the storage system.

15. The apparatus defined in claim 14 wherein the at least one queue comprises a first queue into which requests to the key-value based storage are stored upon receipt.

16. The apparatus defined in claim 14 wherein the processor selects the FEC coding rate based on the object's size.

17. The apparatus defined in claim 14 wherein the processor selects the FEC coding rate based on Quality of Service (QOS) requirements associated with the request.

18. The apparatus defined in claim 14 wherein the processor comprises a classifier to classify the request into a category and selects N based on the category.

19. The apparatus defined in claim 18 wherein the classifier classifies the request into the category based on whether the request is for a write operation or a read operation, file size of the object, and size of the K portions.

20. The apparatus defined in claim 18 wherein N has been computed as a function of at least one backlog statistic.

21. The apparatus defined in claim 20 wherein the at least one backlog statistic is based on a number of download and upload jobs waiting to be started for at least one category.

22. The apparatus defined in claim 21 wherein the at least one backlog statistic is based on a total number of download and upload jobs waiting to be started for all categories into which requests can be classified.

23. The apparatus defined in claim 19 wherein the processor computes a set of thresholds for each category into which a request can be classified and compares a backlog statistic to one or more thresholds in the set of thresholds to determine N.

24. The apparatus defined in claim 23 wherein the thresholds are based on a model of delay statistics of different types of portions of data objects.

25. The apparatus defined in claim 14 wherein the processor:
assigns a distinct key to each of the K portions;
assigns a distinct key to each of N blocks of data resulting from applying the erasure coding to the K portions; and
orders the keys assigned to the K portions and the keys assigned to the N blocks; wherein the processor causes the communication interface to send the N blocks of data using N separate transfers to the storage system by sending all N blocks in parallel on separate connections to the key-value store, and cancels any of the N separate transfers that haven't been completed successfully after K of the N separate transfers have completed successfully.

26. The apparatus defined in claim 14 wherein the processor:
generates a plurality of individual requests, each request for requesting one of the N blocks of data from storage;
applies erasure decoding as each of N blocks are received;
cancels N−K requests that remain outstanding after receiving K out of N blocks; and
returns the object to a requester.

27. An article of manufacture having one or more non-transitory computer readable storage media storing instructions which, when executed by a system, causes the system to perform a method comprising:
receive a data object and a request;
dividing the data object into K portions, where K is an integer;
selecting an FEC coding rate based on backlog associated with at least one queue;
apply FEC coding based on the FEC rate set to the K portions to create N FEC coded data blocks, where N is an integer greater than or equal to K; and
sending the N FEC coded data blocks to a key-value based storage system.

28. The article of manufacture defined in claim 27 wherein the at least one queue comprises a first queue into which requests to the key-value based storage are received.
